(19) United States
(12) Patent Application Publication
(10) Pub. No.: US 2023/0153597 A1
(43) Pub. Date: May 18, 2023

(54) DESIGN AND FABRICATION METHODS OF RUNTIME SELF-TUNING ANALOG INTEGRATED CIRCUITS USING MACHINE LEARNING

(71) Applicant: ANALOG INTELLIGENT DESIGN INC., Morgan Hill, CA (US)

(72) Inventors: Koushik De, Hyderabad (IN); Khanh Minh Le, Morgan Hilll, CA (US); Deepthi Amuru, Hyderabad (IN); Zia Abbas, Hyderabad (IN)

(21) Appl. No.: 17/827,354

(22) Filed: May 27, 2022

Related U.S. Application Data
(60) Provisional application No. 63/361,004, filed on Nov. 18, 2021.

(51) Int. Cl. G06N 3/063; G06N 20/00

(52) U.S. Cl. CPC G06N 3/0635; G06N 20/00

(57) ABSTRACT

An Integrated Circuit with an automatically re-tuning analog circuit is provided. The Integrated Circuit comprises (a) an analog circuit comprising a plurality of tunable components each configured to respond to a plurality of change control bits, (b) a Process, Voltage Temperature (PVT) characteristics monitor comprising a plurality of PVT sensors, (c) a tuning memory embedded with a machine learning (ML) model of the analog circuit and (d) an artificial intelligence (AI) engine configured to receive a PVT signal input from the plurality of PVT sensors and the machine learning model embedded in the tuning memory. Each tunable component is configured to change its electrical characteristics such that together each of the tunable components is enabled to retune the analog circuit to attain a predefined set of electrical characteristics.

### BACKGROUND

### Technical Field

The embodiments herein generally relate to analog integrated circuits, and more particularly, to semiconductor circuit design and fabrication methods of silicon integrated circuits (IC) using machine learning models.

### Description of the Related Art

With analog circuits, some physical conditions and environments encountered on-the-fly are unpredictable, such as the semiconductor process (P) outcomes, excursions over operating voltage (V) and temperature (T) ranges. In the real world, all these parameters act differently on each constituent electrical component in each analog circuit. These effects, reflected in the outputs and electrical characteristics of the chips, will be more dramatic than others. Therefore, operational drifts of PVT away from a nominal value will often adversely detune the analog circuits.

Conventional analog circuits are designed, simulated, and verified using simulation results to operate within a “target” set of PVT conditions specified in a design specification. The PVT conditions in the design specification represent the forecasted PVT conditions expected to be encountered by the analog circuits once fabricated into silicon chips and put into service. Unfortunately, the electrical characteristics of such analog circuits will drift about widely under impact of on-the-fly PVT conditions. Conventional analog circuits just had to accept being detuned on-the-fly by PVT. However, those which experienced detuning beyond specified limits were deemed failures and thrown away or downgraded. In view of the foregoing, there is a need for a solution that can deal with the consequences of PVT detuning in analog circuits, and that can automatically re-tune analog circuits that are predicted to fall off nominal or fail completely.

The allowed variations in each electrical characteristic are captured and bounded in the design specifications by two numbers, low (or Min) and high (or Max). There is usually a midpoint called nominal. The differences between high and low boundaries can often be 300% or more. Preferably, analog circuits operate with their electrical characteristics staying as close as possible to their nominal values. This in turn enable lower power consumption, increase speed, increase accuracy and provide other benefits, depending on the unique nature of the analog circuit.

An analog circuit is acceptable when it meets its design specifications, as is verified by simulation testing that all its electrical characteristics are well within the bounds of their respective low and high specification values. Once verified, the circuit design can then be advanced to layout and fabrication into silicon chips.

In service, the silicon chip can be subjected to widely varying VT conditions. There can be many sources of VT changes. For example, voltage fluctuations can come from the external supply, on-chip voltage drops, or both. Temperature fluctuations can come from the environment the chip is in, or from the internal rise in die temperature due to self-heating, or both. In addition, the chip can be the result of unpredictable variations in the manufacturing process (P) from one batch to another. In response to the such PVT conditions, the affected electrical characteristics of the analog circuit on silicon vary widely on-the-fly. But as long as these electrical characteristics stay within the high and low values in the design specifications, the chip will be acceptable, because it can be expected to operate within its specifications.

As the complexity of analog circuits increases, no design can ever be fully verified for all possible PVT conditions. Mainly because of the sheer variety of conditions. For example, the number of PVT conditions for an industry-standard “22FDSOI” process is above 2,000. Therefore, the number of simulations that would be required to check every of the 2,000 PVT conditions can be 100,000 or more, depending on the circuit complexity.

Analog design engineers are only human and cannot simulate and review all results for all cases. But they still try to design the best possible circuit configurations, run simulations for the worst-case PVT conditions they can think of, evaluate their results, and iterate until the specifications are met. And hope then they have done everything right and have sampled enough conditions.

It is highly probable that chip designers will miss particular combinations of PVT that can cause the design to fail. The analog design engineers essentially throw a Hail Mary when releasing their design onto silicon. They cannot know what they missed. Worse, they cannot go back to make any adjustments because the design is already cast on silicon. Many analog circuits can thus meet their specifications in the design phase, but still end up failing on silicon. 40% of ASIC re-spins in 2020 were caused by out-of-tolerance analog circuits (Semi Engineering, October 2020).

The present inventors see there is a need to measure the actual PVT conditions the silicon chip encounters at any moment while operating, and then on-the-fly re-tune the electrical characteristics of the analog circuit on silicon to within the design specifications.

Such re-tuning, in response to the PVT conditions, can be implemented by pushing controls on the electrical characteristics of particular constituent components known to have the largest correlation with the electrical characteristics of the analog circuit over the PVT conditions. This kind of re-tuning results in narrower excursions of the electrical characteristics over an expected range of PVT conditions. Other benefits include lower power consumption, higher speed, higher accuracy, and others, depending on the nature of the analog circuit. Re-tuning can save the high cost and long lead time of ASIC re-spins. Others have conventionally put a silicon chip including the analog circuit on a tester, then simulated the PVT conditions expected to be encountered. On-the-fly electrical characteristics of the analog circuit are monitored, and change controls are pushed to selected, sensitive components in the analog circuit for overall re-tuning of the analog circuit.

In one case, changes are permanently impressed by a programmed blowing of fuses. Particular on-chip electrical fuses in shunt are forced open, in order to change a respective electrical component value. Once a blown-fuse change is complete, there's no going back, and the adjustments are permanently cast onto the chip. There are also only a very limited number of electrical characteristics that can be manipulated this way. There is an added cost associated with testers, test boards, and other tools. Nevertheless, such “chip trimming” is commonly used in the industry during the final test stage of the chip before it is approved to be shipped out of the factory.

PVT sensors and look-up tables (LUT) on the same silicon are also conventional with analog circuits that do on-the-fly re-tuning. These fall short without an execution processor and machine learning because they cannot accurately and completely predict the impacts of unpredictable changes on the electrical characteristics of the analog circuit. Large, significant changes can have volatile results, so this re-tuning method only manages to make a few tweaks to lessen variations in the range of electrical characteristics.

Added overhead is always needed to monitor the electrical characteristics of the analog circuit on-the-fly while re-tuning to stay within the limits imposed by the specifications. Such added circuitry increases the overall complexity and size. So, this re-tuning method has been limited in its scope and range. Very complex systems that occupy large areas of a die and carry more overhead will consume much more area and power than just the analog circuit itself.

Learning which constituent electrical components in particular analog circuits can best have their electrical characteristics manipulated is a job best suited for artificial intelligence, and more specifically machine learning (ML) models. There will be a particular set of manipulations for each PVT that will correctly re-tune the associated analog circuits. In the implementation described herein, such ML models are collocated with their respective analog circuits to realize automatic re-tuning. But the development, training, and testing of respective ML models are done on the analog circuit design platforms based on the results of simulations of the analog circuits over the specified ranges in PVT values. In other implementations, the ML model can reside on another chip(s) or in the cloud but is accessible by the AI engine via a communication channel. In even other implementation, both the ML model and the AI engine can be located on other chip(s) or in the cloud, and only the change control commands are sent to the analog circuits.

In existing technology, a “self-calibration” of analog/RF ICs with on-die learning is performed. More specifically, there is on-chip analog neural network which can be trained to implement a non-linear regression function. A conventional methodology and the corresponding hardware architecture that does such self-calibration and on-chip learning is described by Georgios Volanis, Dzmitry Maliuk, Yichuan Lu, Kiruba S. Subramani, Angelos Antonopoulos, and Yiorgos Makris; ON-DIE LEARNING-BASED SELF-CALIBRATION OF ANALOG/RF ICS; a Conference Paper given April 2016 at the 2016 IEEE 34th VLSI Test Symposium (VTS). Conventional self-healing is described by Martin Andraud and Marian Verhelst in FROM ON-CHIP SELF-HEALING TO SELF-ADAPTIVITY IN ANALOG/RF ICS: CHALLENGES AND OPPORTUNITIES; An IEEE Conference Paper July 2018. A conventional self-healing algorithm measures conditions through sensors attached to a “circuit-to-heal” and computes “tuning knobs” connected back to the circuit-to-heal. Static, quasi-static, and dynamic variations can be experienced. The self-healing algorithm decides each tuning knob setting to apply in response to measured conditions. The circuit can guess, a priori, the “optimal” settings to be applied for each group of possible conditions, from a model built in an off-line characterization phase, before using the circuit in the field. The guesses are then loaded in the circuit in the beginning of its lifetime. In this case the optimal healing states are only characterized off-chip.

Andraud, et al, say that most self-healing methodologies developed in the literature are largely focused on process variations. They go on to say, “Machine learning techniques are then used to correlate the sensor values to the circuit's performances, to predict the performances solely based on the sensor measurements. Both direct and statistical methodologies have been extended to self-calibration procedures where the best combination of tuning setting is found automatically.” If a calibration is reused during lifetime and possibly extended towards self-healing, the full test circuitry must be integrated on-chip, which has been achieved by both direct and statistical methodologies.

Many researchers are focused one-dimensionally on reducing power consumption. Andraud, et al, gave an example of a statistical methodology, which implemented an on-chip neural network in the analog domain. This enabled, after training, a figure of merit (FoM) prediction for a low-noise amplifier (LNA), representative of a trade-off between its main performances. After calibration, the power consumption was significantly reduced for all circuits with minimal impact on performance. However, their strategy was limited to the prediction of one FoM and did not consider several performances explicitly.

Andraud, et al, wrote that with on-chip implementation, self-calibration techniques can be extended towards self-healing. The circuit can then run periodically and compensate for quasi-static variations. They considered only on-chip characterized self-healing techniques, since to the best of their knowledge, off-chip characterized techniques for self-healing only have not been proposed.

Andraud, et al, also wrote that off-chip characterized self-adaptation can be used to avoid needing on-chip optimizers. It being possible to pre-compute so-called optimal settings regarding possible groups of operating conditions, e.g., using statistical techniques. An offline optimization phase is used to build a control law that models relationships between optimal circuit performances and operating conditions, e.g., as measured by on-chip sensors. The control law is then stored in a lookup table (LUT), and subsequently used on-line by the circuit. Sensor values are measured and the corresponding settings are applied regarding the settings indexed in the LUT. The best settings are pre-defined before the circuit lifetime, and are not run fully on-chip which limits the overall system flexibility.

On-chip characterized self-adaptation can only compensate for dynamic variations. Characterizing the optimal states directly on-chip is beyond conventional techniques. Using self-learning, circuits build their own training data by experimenting when the system is not used. It teaches itself the best adaptation settings regarding the conditions experienced. All types of variations can be considered by this technique, and the learning can be updated over a lifetime. Unfortunately, this technique needs a full, embedded processor, limiting the applicability to applications with significant processing capabilities.

Andraud, et al, observed that machine-learning techniques can enable a very compact model representation of a mapping between sensors and tuning knobs. Bayesian Networks (BNs) can be used for a compact representation of a problem and make decisions that are very energy-efficient, compared to classical processors. They also observed that, off-chip characterized methodologies have a significant advantage over on-chip characterized, since a list of “optimal” results are precomputed off-line.

In view of the foregoing, there is a need of an efficient design and fabrication method to measure the actual PVT conditions the silicon chip encounters at any moment while operating. There is also a need to re-tune the electrical characteristics of the analog circuit on the fly to match within the design specifications.

### SUMMARY

In view of the foregoing, an embodiment herein provides an Integrated Circuit (IC) includes an analog circuit, a Process, Voltage Temperature (PVT) characteristics monitor, a tuning memory and an Artificial Intelligence (AI) engine. The analog circuit includes a plurality of tunable components each configured to respond to a plurality of change control bits. Each tunable component is configured to change its electrical characteristics such that together each of the tunable components is enabled to retune the analog circuit to attain a predefined set of electrical characteristics. The Process, Voltage Temperature (PVT) characteristics monitor includes a plurality of PVT sensors. The tuning memory is embedded with a machine learning (ML) model of the analog circuit. The AI engine is configured to receive a PVT signal input from the plurality of PVT sensors and the machine learning model embedded in the tuning memory. The AI engine is configured to: (a) fetch an on-the-fly PVT signal inputs from the plurality of PVT sensors, (b) compute a plurality of analog circuit target control inferences and predictions based the on-the-fly PVT signal inputs and the ML model and (c) generate a plurality of change control bits from the predictions based on the ML model, where the plurality of change control bits activates one or more digital switches to retune the analog circuit.

In some embodiments, the ML model is trained and tested with a plurality of results of a series of design simulations of the analog circuit, where the ML model is stored as a tuning model which represent a correlation between the signal inputs and an output target control variable based on which the AI engine calculates the plurality of analog circuit target control inferences and predictions.

In some embodiments, the tuning model includes either a polynomial model trained with a Gradient Descend method, or as an ensembled-regression model trained with either a Light Gradient Boosting Machine (LGBM) method, or an Extreme Gradient Boosting (XGB) method.

In some embodiments, the ML model is configured to represent changes in the behaviors of the analog circuit under each detected set of PVT conditions to accurately predict the impact of the changes on the electrical characteristics of the analog circuit during the re-tuning process.

In some embodiments, the ML model is configured to identify an electrical characteristic value of each tunable component of the plurality of tunable components to re-tune the analog circuit to attain the predefined set of electrical characteristics.

In some embodiments, the AI engine is further configured to issue on-the-fly change controls to negate adverse de-tuning effects of real-time PVT variations affecting the analog circuit to attain the predefined set of electrical characteristics.

In some embodiments, the IC includes a change control register configured to store the plurality of change control bits through connections to the plurality of tunable components.

In some embodiments, each tunable component of the plurality of tunable components is responsive to at least one single binary control in the plurality of change control bits, where one or more tunable components are identified in circuit design simulations to be more influential than others in re-tuning of the analog circuit.

In some embodiments, the plurality of PVT sensors includes: (a) a first sensor collocated with the tuning memory, the AI engine and the analog circuit configured to provide a real-time measurement of device process outcomes (P), (b) a second sensor collocated with the tuning memory, the AI engine and the analog circuit configured to provide a real-time measurement of operating voltages (V) and (c) a third sensor collocated with the tuning memory, the AI engine and the analog circuit configured to provide a real-time measurement of operating temperatures(T).

In another aspect, a method of automatically re-tuning an analog circuit on an Integrated Circuit. The method including (a) configuring a plurality of tunable components of the analog circuit to respond to a plurality of change control bits, (b) obtaining, by a PVT monitor comprising a plurality of PVT sensors, a plurality of PVT signal inputs, (c) reconstituting, by a tuning memory, a Machine Learning (ML) model from a tuning model embedded in the tuning memory to infer and calculate predictions based on the plurality of PVT signal inputs sensed by the plurality of PVT sensors, (d) fetching, by an artificial intelligence (AI) engine, on-the-fly PVT signal inputs from the plurality of PVT sensors, (e) computing, by the AI engine, a plurality of analog circuit target control inferences and predictions based the on-the-fly PVT signal inputs and the ML model and (f) generating, by the AI engine, a plurality of change control bits from the predictions based on the ML model, where the plurality of change control bits activates one or more digital switches for automatically retuning the analog circuit. Each tunable component is configured to change its electrical characteristics such that together each of the tunable components is enabled to retune the analog circuit to attain a predefined set of electrical characteristics.

In some embodiments, the ML model is trained and tested with a plurality of results of a series of design simulations of the analog circuit, where the ML model is stored as a tuning model which represents a correlation between the signal inputs and an output target control variable based on which the AI engine calculates the plurality of analog circuit target control inferences and predictions.

In some embodiments, the method includes enabling the ML model to represent changes in behaviors of the analog circuit under each encountered set of PVT conditions to accurately predict the impact of the changes on the electrical characteristics of the analog circuit during the re-tuning process.

In some embodiments, the ML model is configured to identify an electrical characteristic value of each tunable component of the plurality of tunable components to re-tune the analog circuit to attain the predefined set of electrical characteristics.

In some embodiments, the method includes configuring the AI engine to issue on-the-fly change controls to negate adverse de-tuning effects of real-time PVT variations affecting the analog circuit.

In some embodiments, the method includes providing a change control register configured to store the plurality of change control bits via connections to the plurality of tunable components.

In some embodiments, each tunable component of the plurality of tunable components is responsive to at least one single binary control in the plurality of change control bits, where one or more tunable components are identified in circuit design simulations to be more influential than others in re-tuning of the analog circuit.

In some embodiments, the plurality of PVT sensors includes (a) a first sensor collocated with the tuning memory, the AI engine and the analog circuit configured to provide a real-time measurement of device process outcomes (P), (b) a second sensor collocated with the tuning memory, the AI engine and the analog circuit configured to provide a real-time measurement of operating voltages (V) and (c) a third sensor collocated with the tuning memory, the AI engine and the analog circuit configured to provide a real-time measurement of operating temperatures(T).

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a functional block diagram of a design platform and a silicon chip that results in a layout and fabrication according to some embodiments herein;

FIG. 2 is a functional block diagram of an embodiment of the present disclosure for a silicon chip according to some embodiments herein;

FIG. 3 is a functional block diagram of an analog silicon chip implementation as fabricated by a factory according to some embodiments herein;

FIG. 4 is a functional block diagram of an embodiment of a self-tuning analog silicon chip designed from a set of circuit design specification standards according to some embodiments herein;

FIG. 5A is a graphical representation of a ML-based heat map for sensitivity analysis, according to some embodiments herein;

FIG. 5B is a flow diagram illustrating a method for creating the ML model in the design phase and the subsequent on-chip re-tuning process according to some embodiments herein;

FIG. 6 is an exemplary 4-phase design flow diagram for an automatically self-tuning analog circuit such as described by FIGS. 1-3 according to some embodiments herein;

FIG. 7 is a flowchart illustrating an ML-based self-tuning analog circuit design process use according to some embodiments herein; and

FIG. 8 is a flowchart illustrating a self-tuning process as executed by an AI engine on silicon chips, according to some embodiments herein;

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

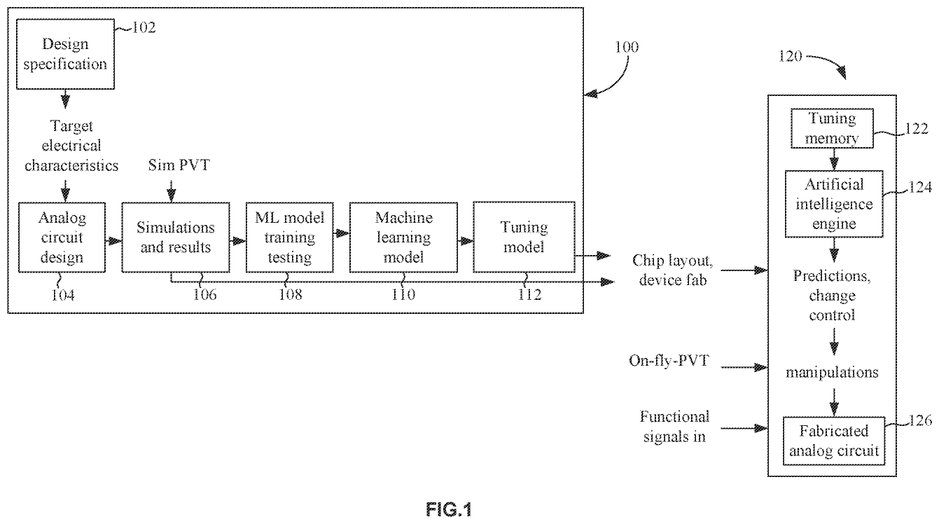

As mentioned, there remains a need for Integrated Circuit for automatically re-tuning an analog circuit. Referring now to the drawings, and more particularly to FIGS. 1 through 8, where similar reference characters denote corresponding features consistently throughout the figures, there are shown preferred embodiments.

FIG. 1 represents a design platform 100 and a silicon chip that results in a fabrication as used herein. The hardware and software parts of design platform 100 are more-or-less familiar and conventional. Such platform assists a chip designer in circuit capture, netlist development, circuit simulations, and machine learning (ML) model development, training, and testing.

Everything starts with an analog circuit specification 102 wherein an analog and its overall electrical characteristics are givens. These include the semiconductor fabrication processes (P) and materials, and the operating environment ranges of supply voltages (V) and temperatures (T) for the silicon chip. Some target electrical characteristics of the analog circuit are defined herein as “nominal”. Usually that means a midpoint between high and low extremes. The objective of the silicon chip design is to have it on-the-fly tuned to its nominal overall electrical characteristics, despite on-the-fly variations in PVT.

An analog circuit design 104 is captured as a netlist and submitted to a series of simulations over three simultaneous ranges of PVT. What's being looked for is how the analog circuit design 104 becomes detuned from nominal as PVT varies. A simulations and results module 106 trains and tests for what electrical characteristics of each electrical component within the analog circuit design 104 can best be manipulated to re-tune the analog circuit design 104 back to nominal at any given PVT (within the specified ranges of each). Some of the electrical characteristics of particular electrical components being controlled and manipulated within the analog circuit design 104 will dominate in their abilities to re-tune the analog circuit overall to nominal specifications. Such are preferably selected for use. The remainder can be ignored for economy. An ML model testing and training module 108 produces an ML model 110. This then is reduced to its essence, a tuning model 112. Simulations and results module 106, ML model testing and training module 108, and ML model 110 are unique and novel with the present disclosure.

ML modeling may be done, for example, using existing OpenSource tools such as Spyder, Jupyter notebook from Anaconda, coupled with a standard language like R or Python. Anaconda is a free and open-source distribution of the Python and R programming languages for scientific computing. Google Colab is a hosted Jupyter notebook from Google Corporation that provides free access to computing resources including GPUs that are well suited for Machine Learning and data analysis. A large data set is obtained by performing simulations of the circuits and process monitors with many PVT data points in step 106. An ML model 110 is obtained by performing statistical analyses on the data set. The accuracy of the ML model is then assessed by comparing its predicted output values across the PVT input ranges to those from simulation results.

The ML modeling method with the present disclosure involves a set of statistical processes for estimating the relationship between dependent variable(s) and one or more independent variables of the analog circuit design 104, from the simulations and results 106. These relationships either in the form of equations or as regression tree (depending on the statistical process) in 110 are stored as ML tuning memory 122 on the chip 120. The ML model training and testing phase 108 analyzes the simulation data 106 and discover the dominant parameters through data exploratory analysis. For any analog circuit, its electrical characteristics depend on the PVT conditions and the changes of the electrical characteristics of its constituent components according to the PVT conditions. However, some components may be “dominant”, meaning that changes in their electrical characteristics over PVT affect the overall electrical characteristics of the analog circuit much more strongly than those of most other constituent components. In this context, the dominant parameters are P, V, T, and the electrical characteristics of the “dominant” components. They are entered as variables in the statistical analyses below. Exploratory analysis on 106 involves heatmap, pair plots that captures the correlation between different variables through Pearson's Correlation Coefficient. Pearson's Coefficient is a measure of linear correlation between two sets of data. It is a normalized measurement of covariance that results in a value between 1 and −1. A Pearson's coefficient value nearer to 1 indicates a strong positive correlation. If nearer to −1 it indicates strong negative relationship between two variables. Any value around zero indicates two variables are un-correlated. The un-correlated parameters are identified through user-defined thresholds based on the design specification 102 and can be ignored to keep the ML model 110 simple and reduce computation time. Accurately identifying the non-dominating parameters through data exploratory and ignoring them for ML model training doesn't trade-off model accuracy.

The training process 108 of the ML model 110 thereon takes as inputs only the dominant parameters and separates the data into training and testing datasets randomly. An ML model 110 is built on training data with Regression methods such as Gradient Descend or Gradient Boosting. An optimization method such as Gradient Descent is called as a part of the regression method to minimize the cost function (L2norm). Hyper parameters such as learning rate, number of iterations are tuned to achieve a cost function value nearly zero. The accuracy is measured in terms of Mean Square Error and R2Score. The mean square error is the average of the square of the difference between actual and predicted values from the ML model 110. The coefficient of determination, R2Score is a statistical measure that represents the proportion of the variance of the dependent variable that is best explained by the independent variables in the regression model. The hyper parameter tuning is carried out in a feedback loop until R2Score is more than 0.95, that indicates accurate training. The accurately trained ML model specific to the analog circuit being designed, is stored in a suitable format to be later called up to perform prediction calculations.

After the analog circuit 104 is handed off to chip layout and device fabrication, a silicon chip 120 is produced. The ML model 110 is now cast into and stored in a tuning memory 122. On-the-fly the AI engine 124 will use the tuning memory 122 to perform predictions and choose which change controls and manipulations of the so-called “dominant” constituent electrical components of fabricated analog circuit are predicted to re-tune the fabricated analog circuit 126 (Such represents the analog circuit design 104 in conformance with the analog circuit specification 102.) to overall nominal standards given on-the-fly measurements of PVT. Such measurements are typically provided by collocated PVT sensors (not shown in FIG. 1).

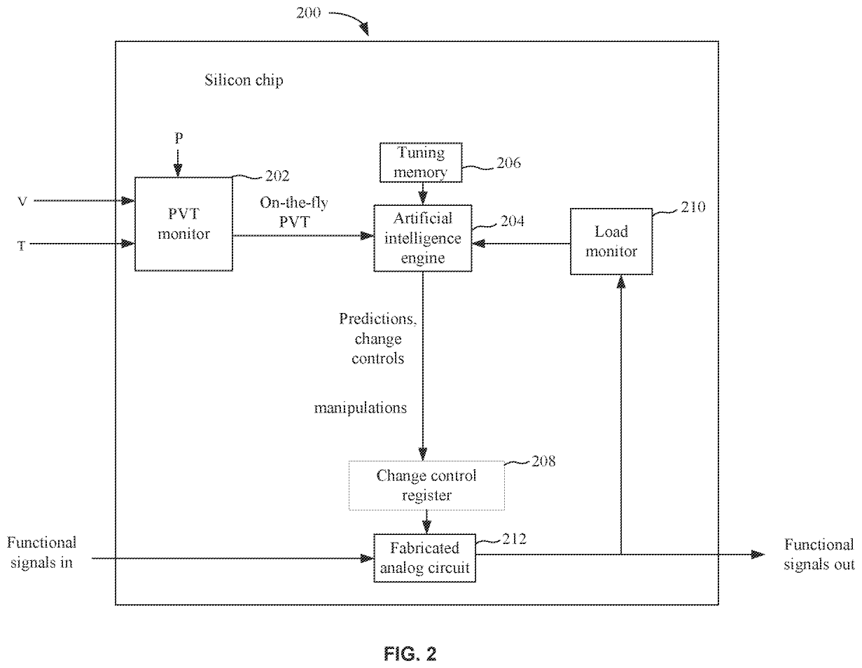

FIG. 2 represents an embodiment of the present disclosure for a silicon chip 200. Such is similar to silicon chip 120 (FIG. 1), but is more specific in some of its details. A PVT monitor 202 senses the local voltage (V) and temperature. The PVT monitor 202 also senses what resulted in the device fabrication process (P), e.g., fast, typical, or slow. “P”, of course remains fixed for the life of the chip 200. However, what results as “P” cannot be predicted beforehand, because it's a random result of the chip fabrication. “V” and “T” can be expected to vary unpredictably during the use of chip 200.

In one embodiment of the present disclosure, the PVT monitor 202 includes a first sensor collocated with the tuning memory, the AI engine and the analog circuit on the silicon chip. It is configured to provide a real-time measurement of device process outcomes (P). The PVT monitor 202 further includes a second sensor collocated with the tuning memory, the AI engine and the analog circuit on the silicon chip and configured to provide a real-time measurement of operating voltages (V). The PVT monitor 202 further includes a third sensor collocated with the tuning memory, the AI engine and the analog circuit on the silicon chip and configured to provide a real-time measurement of operating temperatures (T). The first, second, and third sensors simultaneously together provide PVT measurements to the AI engine 204 in real-time on-the-fly operation.

Alternatively, the PVT monitor 202 includes a first signal input configured to accept a real-time measurement of device process outcomes (P). And it also includes a second signal input configured to accept a real-time measurement of operating voltages (V). The PVT monitor 202 further includes a third signal input configured to accept a real-time measurement of operating temperatures (T). Here, the first, second, and third signal inputs simultaneously together provide PVT measurements to the AI engine 204 in real-time on-the-fly operation. The on-the-fly PVT is forwarded to an AI-engine 204. A tuning memory 206 stores the tuning model derived from an ML model as illustrated by FIG. 1. From the on-the-fly PVT the AI-engine 204 reads the ML model distilled as tuning model in tuning memory 206 and computes predictions, change controls, and manipulations. These outputs are latched into a change control register 208. In some embodiments, a load monitor 210 senses the functional signals being output from a collocated fabricated analog circuit 212. The load monitor readings are also fed into the AI-engine 204 to include them in the predictions, change controls, and manipulations from the on-the-fly PVT and the ML model distilled as tuning model in tuning memory 206.

In another embodiment, the change control register 208 is connected and configured to accept and store a first plurality of digital control bits in parallel from the AI engine 204, and to apply a second plurality of digital control bits stored in parallel to manipulate and maintain the plurality of electrical characteristics of the internal “dominant” components of the analog circuit 212 on the silicon chip 200. The load monitor 210 is configured to sense loading and usage changes, electrical interference, and/or distortion affecting the analog circuit 212, and provides such results to the AI engine 204. The AI engine 204 infers from the usage and environmental PVT conditions a particular re-tuning control for manipulating and maintaining the plurality of electrical characteristics of the internal “dominant” components of the analog circuit 212 on the silicon chip 200 needed to re-tune it.

The ML models are trained and tested with the results of a series of simulations of the analog circuit design, and is memorialized as a set of polynomial equations that together represent a complex relationship between PVT input variables and output target control variables to alter the electrical characteristics of said analog circuit. Alternatively, the ML model is trained and tested with the results of a series of simulations of the analog circuit design, is instead memorialized as an ensembled-regression model that together represents a complex relationship between PVT input variables and output target control variables to alter the electrical characteristics of said analog circuit.

The ML models are coded into a plurality of digital bits which are stored as the tuning model and from which the AI engine calculates a plurality of analog circuit target control predictions and inferences derived from such. The ML model could also be stored in a read-only or a writeable lookup table from which the AI engine calculates a plurality of analog circuit target control predictions and inferences. The AI-engines preferably include a central processing unit (CPU) with an executable program, to calculate from the ML model stored as tuning memory, a plurality of analog circuit target control predictions and to infer therefrom, and thereafter output to the change control register.

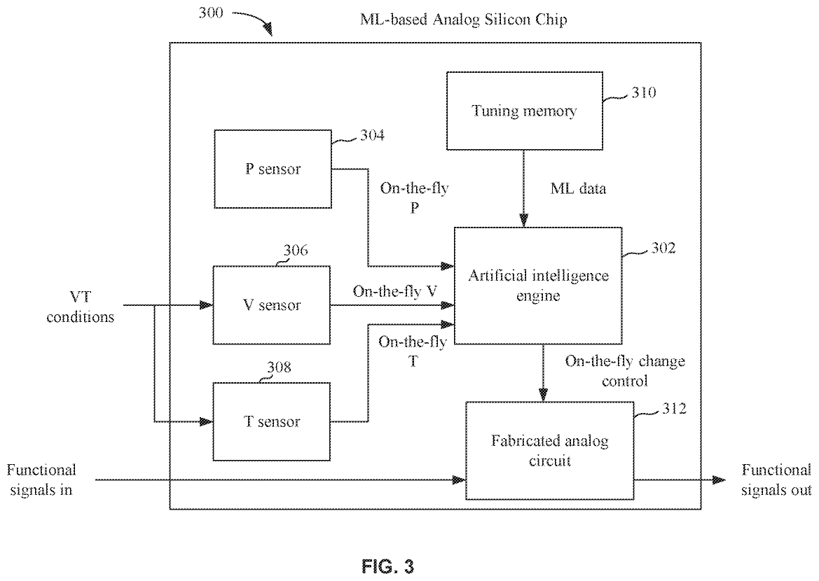

FIG. 3 represents what the implementation on silicon looks like in practice. An ML-based analog silicon chip 300 includes an artificial intelligence (AI) engine 302. PVT are sensed and measured on-the-fly by a P-sensor 304, a T-sensor 306, and a V-sensor 308. All together, they provide the instant PVT signal inputs to the AI-engine 302. The AI-engine 302 uses these and the information stored in tuning memory 310 to infer the changes needed and calculate the on-the-fly change controls to a fabricated analog circuit 312. In some embodiments, re-tuning is made practical by collocating PVT sensors and an AI engine with onboard memory on the same silicon as the analog circuit. Then the necessary calculations and predictions can be done using an efficient machine learning model stored in the onboard memory. Machine learning here enables analog circuits to re-tune themselves in response to real PVT conditions. Embodiments of the present disclosure can automatically bring their electrical characteristics back to within a few percent of their nominal values.

The machine learning models here are created, trained, and tested with simulation results that cover the hundreds of thousand possible PVT conditions to eliminate simulation misses. The machine learning models accurately represent the changes in behavior of the analog circuit under each encountered set of PVT conditions to accurately predict the impact of the changes on the electrical characteristics of the analog circuit during the re-tuning process. Re-tuning is achieved on-the-fly without additional monitoring circuits. The scope and range of re-tuning is also wider. It is done with confidence as the impact of any changes is predicted to be safe. Achieving such accurate re-tuning would result in many cases in the lowest variations of the electrical characteristics over the range of PVT conditions, down to just a few percent from the nominal values. It also provides many benefits like lower power consumption, higher speed, higher accuracy, etc. Finally, re-tuning will eliminate the need for ASIC re-spins, saving on the high cost and long lead time.

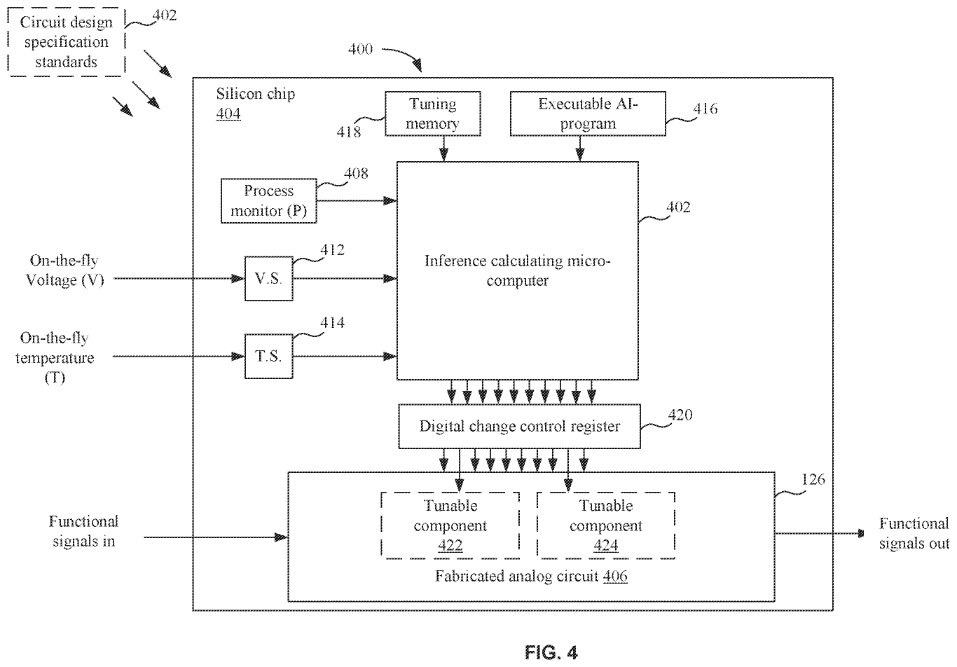

FIG. 4 represents a design diagram 400 that begins with a set of circuit design specification standards 402. From these, a silicon chip 404 is produced in fabrication and put in service in an unpredictable PVT environment. The main purpose of silicon chip 404 is to provide a “tunable” analog circuit 406 that allows functional analog input signals to produce functional analog output signals according to circuit design specification standards 402.

For example, tunable analog circuit 406 could be a low noise amplifier (LNA), an example of which is an LNA design discussed in Practical Considerations for Low Noise Amplifier Design, by Tim Das, a Freescale Semiconductor White Paper, May 2013. Here, circuit design specification standards 402 would speak to the process technology and the transistor geometry, and other LNA performance variables. The acceptable deviations it defines include the mid-point nominal values. An LNA meeting all the mid-point nominal values is in-tune. What results after fabrication is what is referred to herein as (P). A ring oscillator, for example, can be used to indirectly measure (P). An on-chip process monitor 408 provides the (P) in PVT to an inference calculating micro-computer 410. The ML model 110 was deposited in fabrication as tuning memory 418 on silicon chip 404.

Measured (P) will always differ from the ideal, nominal conditions set in circuit design specification standards 402. That difference is how much out-of-tune the LNA is for the on the-fly process condition (P). (P is a static condition, but still unpredictable in the circuit design phases. An on-chip voltage sensor 412 provides the (V) in PVT by measuring the on-the-fly operating voltage that tunable analog circuit 406 is supplied with. The V-measurement is taken in by the inference calculating micro-computer 410.

An on-chip temperature sensor 414 provides the (T) in PVT by measuring the on-the-fly operating temperature that tunable analog circuit 406 is experiencing. The T-measurement is taken in by the inference calculating micro-computer 410. An executable AI-program 416 run by the inference calculating micro-computer 410 uses tuning memory 418 to calculate digital control bits from the PVT being measured on-the-fly. A digital change control register 420 holds these so the inference calculating micro-computer 410 can go back to sleep or do other tasks. Each digital control bit is connected to a tunable component 422, 424 within the tunable analog circuit 406.

An ML model that was built, trained, and tested in circuit design simulations has been distilled into its essence, coded, and stored as tuning memory 418. Such machine learning model is used by the inference calculating micro-computer 410 to predict and generate the correct digital control bits predicted to be needed to put tunable analog circuit 406 back in-tune, given the instant on-the-fly PVT. The predicted necessary tuning that results is not tested on-the-fly as it was already tested in circuit design simulations for each possible PVT. The ML model is used by the inference calculating microcomputer 410 to find a value of a tunable component 422, 424 that is required to bring the output tunable analog circuit 406 to a nominal value given as specification standards 402. Then the inference calculating micro-computer 410 creates a digital control code for the digital control change register 420 to turn on/off the right tuning.

Each tunable component 422, 424 could either be responsive to a single binary control, or several. For example, a component resistor R that is switchable between 1K ohms and 1.2K ohms. Or if several control bits are used, then switchable amongst the values of 1K, 1.2K, 2.2K, 2.7K, and 3.3K ohms. Each and all tunable components 422, 424 have some influence over the tuning overall of tunable analog circuit 406. But various tunable components 422, 424 will have more influence than others. These are sorted out in circuit design simulations and only the more influential (dominant) ones are worthwhile being controlled with the digital control change register 420.

The tunable analog circuit 406 is always on-line and available to process its analog inputs into its specified analog outputs. The inference calculating micro-computer 410 runs independently and in parallel with the tunable analog circuit 406. The more complex or critical the analog circuits are to the functionality and integrity of the systems on chips (SOCs), the more users will find the benefits in AI-driven self-adapting analog design methodology described herein. Embodiments of the present disclosure can be advantageously applied to embedded static random-access memory (SRAM), flash memories, all chip interfaces, and especially high-speed SerDes, DDR/LPDDR, specialty input/outputs (IOs), Audio/Video functions, on-chip radio frequency (RF) functions, Power management, Data converters, and much more. (LPDDR is an abbreviation for Low Power Double Data Rate, also known as LPDDR SDRAM, is a type of synchronous dynamic random-access memory that consumes less power and is targeted for mobile computers. Older variants are also known as Mobile DDR, and abbreviated as mDDR).

A first protype circuit to which an embodiment of the self-adaptation methodology herein applied was a voltage-independent current reference implemented in a standard 40 nm CMOS process. The performance of the current reference depends on the characteristics and variations in its MOS transistors and a resistor R over PVT conditions. R was pinned as a tunable component 422, 424.

### Example 1, Tunable Analog Circuit 406 is a Current Reference

| Electrical | | | | | | | |
|---|---|---|---|---|---|---|---|
| characteristic | | | | | | | |
| over PVT | Legacy | | | AI-design | | | |
| Specification | Min | Typical | Max | Min | Typical | Max | Comments |
| Iref (μA) | 8 | 10 | 13 | 9.8 | 10 | 10.1 | 50% spread |
| | | | | | | | reduced to |
| | | | | | | | 3% |
| Accuracy | 6.13 | 10.25 | 221.7 | 10.1 | 10.25 | 10.4 | 21x |
| (ppm) | | | | | | | accuracy |
| | | | | | | | improvement |
| Line | 0.06 | 0.07 | 0.16 | 0.01 | 0.01 | 0.01 | Line |
| sensitivity | | | | | | | sensitivity |
| (%/V) | | | | | | | improved |
| | | | | | | | by 16x |
| PSRR (dB) | −68 | −91 | −93 | 90 | −91 | −91 | 23 dB better |
| | | | | | | | PSRR |
| Power (mW) | 18.82 | 54.2 | 140.2 | 54 | 55 | 55 | 2.5x lower |
| | | | | | | | power |

To set up a machine learning model, the sensitivity relationships between a reference current and the PVT variables were determined by running a dedicated set of simulations using Cadence Spectre. Then, 41,393 simulations were run with different values of PVT and the results delivered to generate a corresponding ML model. That training data set included 90% of the 41,393 samples, with the remaining 10% of them split out for the test data set. Statistics comparing actuals from simulations to ML model predictions were collected of the mean, standard deviation, variance, and errors of the reference current across the PVT range as predicted by the machine learning model. Extremely low errors of 1% or less were observed, The flow of ML modeling for the Current Reference dataset is,

Step 1: Access the simulated data.
Step 2: Current Reference circuit has 5 parameters. As per the given specifications, ‘Current’ is defined as the output parameter and the other four parameters are defined as the input parameters:

Input parameters—Supply (Supply voltage variations)

Temp (Temperature variations)

Freq1 and Freq2 (Variations on process)

Output parameter—Current (μA)

Step 3: Perform thorough exploratory analysis to identify the dominant parameters. Sensitivity analysis through heatmap, pair plot is involved. From the heatmap, covariance between a set of two variables computed using Pearson's Correlation Coefficient is observed either manually or automatically through user-defined threshold value decided based on domain knowledge. Further, dominant parameters influencing the output are identified. The Pearson's Coefficient, r is a measure of linear correlation between two sets of data.

$$r = \frac{\sum ( {x}_{i} - \overline{x} ) ( {y}_{i} - \overline{y} )}{\sqrt{\sum {( {x}_{i} - \overline{x} )}^{2} \sum {( {y}_{i} - \overline{y} )}^{2}}}$$

Where, xᵢ is the ith sample value of the input variable
yᵢ is the ith sample value of the output variable
x̅, y̅ are the mean values of input and output variables respectively.

The value of Pearson's Coefficient lies in the range −1 to 1. 1 indicates a strong positive correlation between the two sets of data/parameters. −1 indicates a strong negative correlation. A Pearson Coefficient value near zero indicates weak correlation.

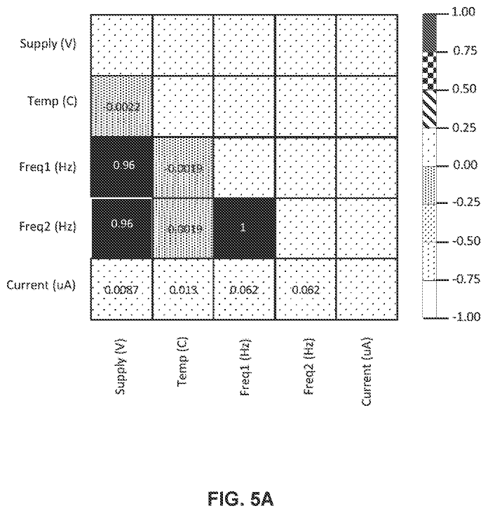

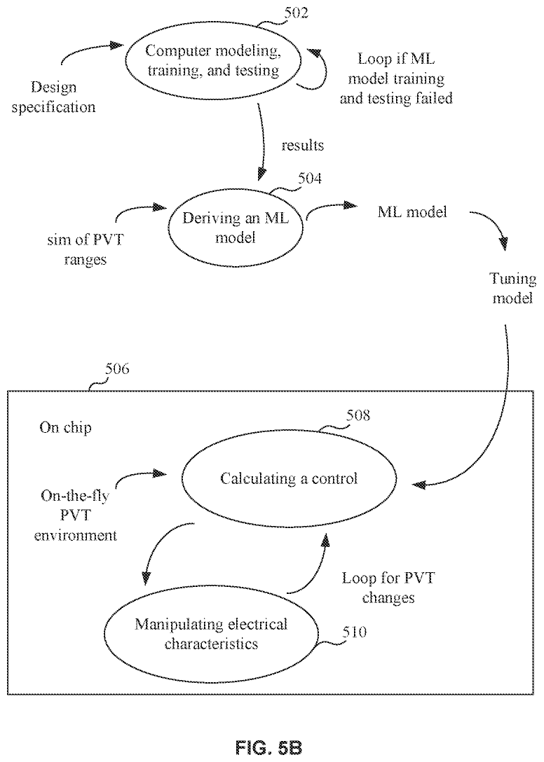

FIG. 5A is a graphical representation of a ML-based heat map for sensitivity analysis, according to some embodiments herein.

Freq1 is the oscillation frequency of Process Monitor 1 which consists of inverters made from NMOS and PMOS transistors. The variations of Freq1 over PVT are dominated by the variations of the electrical characteristics of both NMOS and PMOS transistors. Freq2 is the oscillation frequency of Process Monitor 2 which consists of inverters made from NMOS, PMOS transistors and resistors. The variations of Freq2 over PVT are dominated by the variations of the electrical characteristics of the resistors, the NMOS and PMOS transistors. The heat map shows the correlations between Freq1, Freq2, Current, Temperature and Voltage which are inputs used to train the ML model.

As per the heat map, all the input parameters show nearly the same covariance with respect to ‘Current’ (output). None of the parameters are quite dominating the output. Hence, all the input parameters are considered for training.

Step 4: The simulated data is normalized and separated randomly for training (90%) and testing (10%).
Step 5: As the simulated data consists of continuous data, regression models such as polynomial regression and ensembled regression are chosen for training. Three methods—Gradient Descend, Light Gradient Boosting Machine (LGBM), and Extreme Gradient Boosting (XGB) are identified as suitable methods for training the ML models of the analog circuits in the present disclosure.

### 1. Polynomial Regression Model

Choose a degree of polynomial through domain knowledge, based on the number of input parameters. The degree of the polynomial influences the complexity, computation time and accuracy of the model. With domain knowledge, with 4 input parameters in ‘Current Reference’ circuit, degree of the polynomial can be chosen as 3 and based on the accuracy after training, higher order polynomials can be chosen if required and continue training within a loop.

The resultant third order polynomial regression equation for current reference simulated data is given as:
Ŷ(Predicted Current)=a₀+a₁*Supply+a₂*Temp+a₃*Freq1+a₄*Freq2+a₅*Supply²+a₆*Temp²+a₇*Freq1²+a₈*Freq2²+a₉*Supply*Temp+a₁₀*Supply*Freq1+a₁₁*Supply*Freq2+a₁₂*Temp*Freq1+a₁₃*Temp*Freq2+a₁₄*Freq1*Freq2+a₁₅*Supply³+a₁₆*Temp³+a₁₇*Freq1³+a₁₈*Freq2³+a₁₉*Supply²Temp+a₂₀*Supply²Freq1+a₂₁*Supply²Freq2+a₂₂*Temp²Supply+a₂₃*Temp²Freq1+a₂₄*Temp²Freq2+a₂₅*Freq1²Supply+a₂₆*Freq1²Temp+*Freq1²Freq2+a₂₈*Freq2²Supply+a₂₉*Freq2²Temp+a₃o*Freq2²Freq1

The ML model (Polynomial regression model with degree 3 according to this disclosure) returns the coefficient values after training in the above equation structure based on the number and order of the input parameters in the training data. The following are the coefficient values a0, a1, . . . , a30 returned from the model after the training:
[−1.39961869e-13 4.81943893e-07 −7.20391110e-09 −5.22493854e-05 5.21420639e-05 −1.07498902e-06 −3.60088947e-08 5.27899772e-05 −5.08299685e-05 −6.45494019e-10 3.83975260e-08 −1.13040668e-10 −3.92107664e-08 7.20399552e-05 −5.85475993e-05 5.32088364e-10 −2.91115588e-07 3.69795076e-07 −3.17143206e-03 6.16992678e-03 −3.00308212e-03 −936803627e-11 1.12170918e-08 −1.19472949e-08 4.29003305e-05 −8.48980341e-05 4.19677852e-05 1.89440933e-02 −5.34640149e-02 5.02309536e-02 −1.57091933e-02]

The polynomial equation (with degree 3) chosen for ‘Current Reference’ data is trained with Gradient Descent optimizer towards finding the minima of the cost function,

$$J = \frac{1}{2 m} {\sum }_{i = 1}^{n} {( {y}_{i ( actual )} - {\hat{y}}_{i ( predicted )} {}^{\hat{}} )}^{2}$$

Where, n represents number of training samples

yᵢ(actual) is the ‘Current’ (output) value of the i^{th} input sample from simulated data (actual data)

yᵢ(predicted) is the predicted ‘Current’ (output) value of the i^{th} input sample from ML model (predicted data)

### 2. Gradient Descent Method:

For n data points (xᵢ,yᵢ), i=1, 2, . . . n
1. Choose initial set of coefficients randomly or as zeros; a=[a₀ a₁ a₂ . . . a₃₀]
2. For the chosen set of initial coefficients, calculate the corresponding output
3. Ŷ(Predicted Current)=a₀+a₁*Supply+a₂*Temp+a₃*Freq1+a₄*Freq2+a₅*Supply²+a₆*Temp²+a₇*Freq1²+a₈*Freq2²+a₉*Supply*Temp+a₁₀*Supply*Freq1+a₁₁*Supply*Freq2+a₁₂*Temp*Freq1+a₁₃*Temp*Freq2+a₁₄*Freq1*Freq2+a₁₅*Supply³+a₁₆*Temp³+a₁₇*Freq1³+a₁₈*Freq2³+a₁₉*Supply²Temp+a₂₀*Supply²Freq1+a₂₁*Supply²Freq2+a₂₂*Temp²Supply+a₂₃*Temp²Freq1+a₂₄*Temp²Freq2+a₂₅*Freq1²Supply+a₂₆*Freq1²Temp+a₂₇*Freq1²Freq2+a₂₈*Freq2²Supply+a₂₉*Freq2²Temp+a₃₀*Freq2²Freq1
4. Calculate Cost function,

$$J = \frac{1}{2 m} {\sum }_{i = 1}^{n} {( {y}_{i ( actual )} - {\hat{y}}_{i ( predicted )} {}^{\hat{}} )}^{2}$$

5. Improve the coefficient values towards finding the minima of the cost function by using

a=a−α∇_{w}J
where, α is the learning rate; ∇_{w}J is the gradient of the cost function
6. Stop after meeting the stopping criterion like required user defined accuracy or number of iterations
   For the present disclosure accuracy is measured in terms of R2Score. R2Score above 0.95 is the stopping criteria.
7. The final set of a=[a₀ a₁ a₂ . . . a₃₀] obtained after training are the regression coefficients which define the input-output relationship between ‘Current’ and input PVT parameters (Supply, Temp, Freq1, Freq2).

R2 Score or R-squared or Coefficient of Determination is the statistical measure of fit that represents how much variation of the dependent variable is explained by the independent variable(s) in a regression model. R2Score value lies between 0 to 1. R2Score value of 1 indicates ML model is able to completely explain the variability of the dependent variable. R2Score is calculated with the formula given below.

$${R}^{2} = 1 - \frac{{\sum }_{i = 1}^{n} {( {\hat{y}}_{i} - {y}_{i} )}^{2}}{{\sum }_{i = 1}^{n} {( {y}_{i} - {\overline{y}}_{i} )}^{2}}$$

The Polynomial regression model is stored and can be used for estimating the output of any other input data.

### 3. Gradient Boosting Method

Gradient Boosting for regression is an efficient method to build predictive models of continuous data. Complex regression trees are built from gradient boosting that perform well for small datasets. It is an ensembled technique, also known as additive model that combines simple models (also called as weak learners) one at a time keeping existing trees unchanged. As more and more simple models are combined, a complete final model obtained will be a strong predictor. Gradient boosting also reduces the bias error in the model. It uses gradient boosting to minimize the cost function. Gradient Boosting regression calculates the residuals which are the difference between the actual and the predicted values. The regressor trains a weak model that maps features (which are input and output parameters from given analog circuit) to that of the residuals. These residuals predicted by a weak model is added as input to the existing model and thus model progresses towards the actual target (which is the output variable, ‘Current’). Repeating these steps through several iterations improves the model accuracy and leads to strong (accurate) predictions. LGBM (Light Gradient Boosting Machine), XGB (Xtreme Gradient Boosting) are variants of the Gradient Boosting method. LGBM is several times faster than XGB and much better in modeling large datasets. LGBM has more hyper parameters that can be tuned to produce accurate modeling compared to XGB. The training procedure is similar for both the methods. Broadly, the steps involved in training these models are
1. Select a weak learner (Build an initial regression tree)
2. Use an additive model (to combine the predictions of various weak learners)
3. Define a loss function (L2 norm)
4. Minimize the loss function (Change the weights of the regression trees towards finding the global minima of the loss function through gradient descent method)

The mathematical procedure of gradient boosting method is given below.

Algorithm: Statistical Estimation using Gradient Boosting

| | |
|---|---|
| 1: | while j < k ∀ N |
| 2: | Calculate Pearson coefficient, r for ail process |
| 3: | Perform Sensitivity analysis |
| 4: | endwhile |
| 5: | Determine dominant feature set X |
| 6: | Define target variable y{target} |
| 7: | Call GradientBoosting(y{target},X,hyperparameters) |
| 8: | ${F}_{0} ( x ) = ( \begin{matrix}arg min \\ γ\end{matrix} ) {\sum }_{i = 1}^{N} L ( {y}_{i} , γ )$ |
| 9: | for m = t to M do: |
| 10: | ${w}_{im} = - {[ \frac{\partial L ( {y}_{i} F ( {x}_{i} ) )}{\partial F ( {x}_{i} )} ]}_{F ( x ) = {F}_{m - 1} ( x ) ;} for i = 1 , … , N$ |
| 11: | ${R}_{jm} = ( \begin{matrix}argmin \\ γ\end{matrix} ) {R}_{j} , η {\sum }_{i = 1}^{N} {[ {w}_{im} - η I ( {x}_{i} , {R}_{j} ) ]}^{2}$ |
| 12: | ${γ}_{jm} = ( \begin{matrix}arg min \\ γ\end{matrix} ) {\sum }_{{x}_{i} ϵ {R}_{jm}}^{N} L ( {y}_{i} , {F}_{m - 1} ( x ) + γ ) ; i = 1 , . N$ |
| 13: | ${F}_{m} x = {F}_{m - 1} ( x ) + η {\sum }_{j = 1}^{jm} {γ}_{jm} I ( x ϵ {R}_{jm} )$ |
| 14: | end for |
| 15: | end GradientBoostingAlgorithm |
| 16: | Calculate RMSE, MAE, R2Score |
| 17: | If R2Score < 0.95 |
| 18: | Hyper-parameter fine tuning |
| 19: | Repeat steps 7 to 18 by tuning hyperparameters |
| 20: | until R2Score > 0.95 |
| 21: | end if |
| 22: | return trained GradientBoostingModel |

N represents the number of training samples;
k represents number of parameters in the given dataset;
r represents the Pearson's Correlation Coefficient;
L represents the loss function or cost function (L2norm);
y represents the minimum value of the cost function;
η represents learning rate for gradient descent optimization;
M represents the number of regression trees;
wᵢₘ is the iₜₕ sample of the mₜₕ tree;
Rⱼₘ is the terminal region for jₜₕ leaf node of the mₜₕ tree;

The loss function gets reduced across the trees as the method iterates through additive regression trees till it reaches an optimum value. Optimum value is chosen through R2Score>0.95 for present disclosure. Hyper parameters are tuned to achieve desired accuracy. Hyper parameter tuning involves changing the learning rate, number of regression trees, number of leaf nodes, bagging fraction and so on.

```
Input: training set {(xᵢ, yᵢ)}ᵢ₌₁ⁿ, a differentiable loss function
L(y, F(x)), number of iterations M.
Algorithm:
  1. Initialize model with a constant value:
    ${F}_{0} ( x ) = {arg min}_{γ} {\sum }_{i = 1}^{n} L ( {y}_{i} , γ ) ,$
  2. For m = 1 to M:
    1. Compute so-called pseudo-residuals:
      ${r}_{im} = - {[ \frac{\partial L ( {y}_{i} F ( {x}_{i} ) )}{\partial F ( {x}_{i} )} ]}_{F ( x ) = {F}_{m - 1} ( x )} for i = 1 , … , n .$
    2. Fit a base learner (e.g. tree) hₘ(x) to pseudo-residuals,
    i.e. train it using the training set {(xᵢ, rᵢₘ)}ᵢ₌₁ⁿ.
    3. Compute multiplier γₘ by solving the following one-dimensional
    optimization problem:
      ${γ}_{m} = {arg min}_{γ} {\sum }_{i = 1}^{n} L ( {y}_{i} , {F}_{m - 1} ( {x}_{i} ) + γ {h}_{m} ( {x}_{i} ) ) .$
    4. Update the model:
      Fₘ(x) = Fₘ₋₁(x) + γₘhₘ(x).
  3. Output F_{M}(x).
```

The mathematical procedure of gradient boosting is further broadly described through following steps.

Step 1: Loss function (also called as cost function—L2norm), L is defined.
Step 2 to 5: M regression trees are built across the iterations, and loss function is calculated. To minimize the loss function, its gradients are calculated and weights of the trees in further iterations are modified. Through additive modeling, these trees are combined to form a final complex tree for prediction. The final LGBM or XGB built for best fit is stored and can be used for estimating the output of any other input data. Best fit indicates the accuracy of the model which is determined through R2Score, mean square error (MSE) giving them as a constraint. R2Score greater than 0.95 is given as the stopping criteria. The ML model is ready and stored for further predictions for any set of input parameters.
Step 6: Control Codes Prediction for Re-tuning. The output of the ‘Current reference’ circuit is calculated at defined intervals or with user input for each set of PVT conditions encountered to estimate the variation of the ‘Current’ from its nominal value. For each measured PVT (Supply voltage, Temperature, f1 and f2 as representations of Process variations) which are continuous (numeric) values, the ML model predicts the corresponding ‘Current’ (output). The deviation in the predicted current from nominal value is calculated as ‘Delta’ which is reported in the following table. The digital codes representing the changes of P, V, and T away from their nominal values are also generated as shown in the table below. Those digital codes are used in tuning the target analog circuit. For each set of PVT changes in columns 1 to 4 in the table the corresponding resistance value required to re-tune the analog circuit (i.e., to negate the output deviation due to such PVT changes) is shown in the table below as ‘Resistance’. A set of switches added to the analog circuit are used to change the ‘Resistance’ to bring the output current back to nominal value. Digital codes to change the resistance values are sent as inputs to activate the digital switches. The corresponding digital codes for the resistance values are shown as ‘Control Code’ in the table. To show the accuracy of the LGBM model in predicting ‘Current’, LGBM Delta and Reference Delta (from the simulated dataset used for training) are also shown in the table. For example, for the PVT variations shown in the first row, the variation of the output current as predicted by the LGBM is 9.32E-06 (LGBM Delta) while the variation of the output current as obtained from simulations (Reference Delta) is 9.34E-06. The accuracy is 0.2%.

| | | PMON 1 | PMON2 | | | | |
|---|---|---|---|---|---|---|---|
| VS Codes | TS Codes | Code | Code | LGBM | Reference | | Control |
| (Voltage) | (Temperature) | (Freql) | (Freq2) | Delta | Delta | Resistance | Codes |
| 0000101111 | 1010101011 | 0100000111 | 0100001110 | 9.32E−06 | 9.34E−06 | 53610 | 101100 |
| 0000101111 | 0111010011 | 0011110011 | 0011111011 | 8.91E−06 | 8.93E−06 | 55370 | 100011 |
| 0000000000 | 1000111001 | 0000001110 | 0000001110 | 9.01E−06 | 9.02E−06 | 55260 | 100101 |
| 0101000110 | 0011100011 | 1000101110 | 1000111000 | 9.13E−06 | 9.11E−06 | 54790 | 100111 |
| 1101000110 | 0100011100 | 1101110110 | 1101111011 | 9.44E−06 | 9.44E−06 | 53130 | 101110 |

The 6-bit Control Codes generated from the predictions based on the ML model are given as input for the Control Register, which activates the digital switches accordingly to re-tune the analog circuit to the nominal conditions. To generate the codes from a predicted resistance value, a relative ‘look-up-table’ which consist of resistance versus digital code mapping is used. The resolution and range of codes impacts the accuracy of the re-tuning. There will always be quantization error due to the analog to digital conversion.

A second protype circuit to which an embodiment of the self-adaptation methodology applied was a low drop-out voltage regulator. Voltage regulators are common circuits used for power management. Experiments in simulation were conducted to discover which constituent components of the low drop-out voltage regulator had influence over Vₒᵤₜ (V), Temperature Stability (ppm), Line sensitivity (%/V), Power (mW), PSRR (dB), Load sensitivity, and Phase Margin (°). These influential components were then implemented as tunable components 422, 424.

### Example 2. Tunable Analog Circuit 406 as a Voltage Regulator

| Electrical | | | | | | | |
|---|---|---|---|---|---|---|---|
| characteristics | Legacy | | AI- | | | | |
| over PVT | design | | design | | | | |
| Specification 802 | Min | Typical | Max | Min | Typical | Max | Comments |
| Vₒᵤₜ (V) | 1.6 | 1.853 | 2.145 | 1.8 | 1.853 | 1.855 | Total variation |
| | | | | | | | cut by 10x |
| Temperature | 4.6 | 15.2 | 105 | 15 | 15.2 | 15.5 | Worst case |
| Stability | | | | | | | temperature |
| (ppm) | | | | | | | sensitivity cut |
| | | | | | | | by 7x |
| Line sensitivity | 0.05 | 0.045 | 0.103 | 0.042 | 0.045 | 0.048 | Line sensitivity |
| (%/V) | | | | | | | improved by 2x |
| Power (mW) | 0.28 | 0.62 | 1.5 | 0.62 | 0.62 | 0.621 | 2.4x lower |
| | | | | | | | worst-case |
| | | | | | | | power |
| PSRR (dB) | −44.6 | −57.4 | −71.4 | −58 | −57.4 | −57.3 | Worst case |
| | | | | | | | PS SR improved |
| | | | | | | | by 13.4 dB |
| Load sensitivity | 0.008 | 0.013 | 0.095 | 0.01 | 0.013 | 0.02 | 4x better load |
| | | | | | | | sensitivity |
| Phase Margin | 59 | 75 | 85 | 70 | 75 | 78 | Improved |
| (°) | | | | | | | stability |

FIG. 5B represents a method 500 to create the ML model in the design phase and the subsequent on-chip re-tuning process. Part of the method 500 is executed by the hardware and software parts of design platform 100 before layout or fabrication. The remainder of method 500 executes after that and continually on silicon chip 120 while in use in a real PVT environment. Method 500 uses circuit specification 102 for a step 502 in which netlists are generated and then computer modelling, simulations, ML training, and ML testing proceed. Results are withheld and step 502 loops if the training and testing failed. A step 504 derives a single novel ML model 110 from the results. The ML model is expressible and storable as equations with known coefficients. It could also be structured as a lookup table.

A part of method 500 executes repetitively (in AI-engine 122) on-chip in a sub-method 506 either continuously, or with PVT change detected, or periodically, or one-time, or as commanded. A step 508 calculates a series of controls over time to manipulate the dominant components of the analog circuit 126 according to data in the tuning memory 122 and on-the-fly PVT. One embodiment of an integrated circuit (IC) chip comprises at least one analog circuit design whose electrical characteristics, operating environments, and device fabrication processes are defined by a pre-determined analog circuit design specification.

A machine learning (ML) model is trained and tested with results from a series of simulations of the analog circuit design, which were simulated over a first range of device process outcomes (P), a simultaneous second range of operating voltages (V), and a simultaneous third range of operating temperatures (T), together (PVT). The ML model is thereafter held as data in a tuning memory that is collocated with a fabrication of the analog circuit on a silicon chip. An artificial intelligence (AI) engine is collocated with the analog circuit on the silicon chip, and is configured to execute from the tuning memory inference tasks in which it calculates a set of manipulations of a plurality of electrical characteristics to be applied to the internal “dominant” components of the analog circuit on the silicon chip. Such manipulations are predicted to re-tune the analog circuit to the circuit design specification.

The artificial intelligence (AI) engine is further configured to exert a series of on-the-fly change controls to the plurality of internal “dominant” components of the analog circuit on the silicon chip. The artificial intelligence (AI) engine thereafter issues on-the-fly change controls to negate adverse de-tuning effects of real-time PVT variations affecting the analog circuit on the silicon chip.

In another embodiment of the present disclosure, an on-the-fly method automatically re-tunes the electrical characteristics of an analog circuit on a silicon chip. This is started with computer modeling, training, and testing from the results of design circuit simulations of an analog circuit design, a machine learning (ML) model for the responses of the analog circuit design when simulated over a first range of device process outcomes (P), and a simultaneous second range of operating voltages (V), and a simultaneous third range of operating temperatures (T), together (PVT).

An ML model is derived and coded as data that is placed in a tuning memory that is collocated and fabricated with an analog circuit in a silicon chip. A next step calculates, with an artificial intelligence (AI) engine, a control from an on-the-fly measurement of its PVT environment, and from the tuning memory. (The AI engine is also collocated and fabricated with the analog circuit in the silicon chip.)

The electrical characteristics of a plurality of “dominant” constituent components of the analog circuit in a silicon chip are manipulated with the control obtained in the step of calculating. This is used to re-tune it on-the-fly to an overall specification.

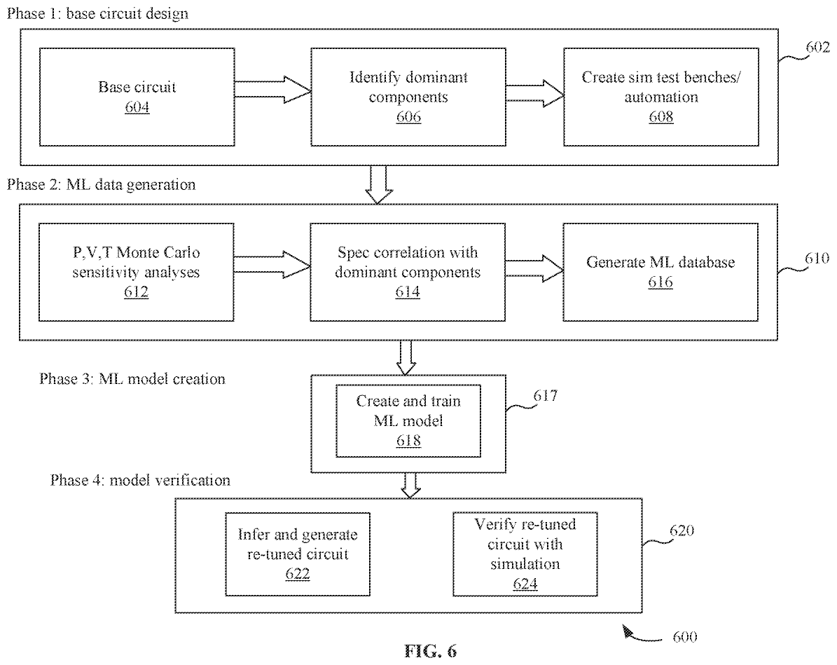

FIG. 6 represents a detailed four-phase design method 600 for a self-tuning analog circuit as described by FIGS. 1-3. Such would be one way to implement the hardware and software parts of design platform 100 (FIG. 1). A phase-1 602 of the design flow 600 may be referred to as “base circuit design”. It starts with a base circuit design 604 which is the process of developing the target circuit configuration that meets the functionality and specifications in a typical set of PVT conditions. Once the base circuit is designed and an initial set of dominant components are identified 606, a set of targeted circuit simulation test benches 608 are developed with the goal of confirming which are dominant components, obtaining the sensitivity relationships between the input signals, environmental conditions, usage conditions, and the electrical behaviors of the base circuit. For any analog circuit, its electrical characteristics depend on the PVT conditions and the changes of the electrical characteristics of its constituent components according to the PVT conditions. However, some components may be “dominant”, meaning that changes in their electrical characteristics over PVT affect the overall electrical characteristics of the analog circuit much more strongly than those of all other constituent components.

In phase-2 610, Monte Carlo and sensitivity analyses 612 in relation to the variables PVT (Process corners, Voltage, Temperature) and all dominant components are performed by circuit simulation from the results. And also, the dominant sources of design sensitivity and their correlation 614 with the various specifications of the circuit are identified, processed and stored 616 in a ML training database.

The dominant components, typical for small circuits, are those MOSFETs, resistors, capacitors, etc. connected in the analog circuit in ways that changes in the electrical characteristics over PVT affect the overall electrical characteristics of the analog circuit much more strongly than those of all other constituent components. Mathematically, the changes in the electrical characteristics over PVT have the strongest correlation factors with the changes in the overall electrical characteristics of the analog circuit over the same PVT range. For very large and complex circuits, dominant components can be whole sub-blocks or circuit functions like amplifier stages, current references, filters, etc.

These circuit simulation results are used to create the machine learning database needed to build the model describing how the electrical characteristics of the circuit are changed with changes in the electrical characteristics of the identified dominant components. In phase-3 617, the ML database created from phase-2 is used to create and train 618 a machine learning (ML) model. Cloud computing resources may be used to crunch a large dataset and perform computational tasks to train and build an ML model.

Finally, in phase-4 620 which is the model verification step, the ML model takes as its inputs several samples of the environmental and usage conditions PVT, and the electrical characteristics of the dominant components then infers the corresponding circuit configuration changes needed to re-tune the operation of the functional base circuit, e.g., to electrically tune it to meet the required tuning criteria, e.g., the nominal specifications (step 622). A design verification step 624 verifies the accuracy of the ML-based re-tuning. The electrical characteristics of the re-tuned analog circuit configurations are predicted from the ML model and compared against the same electrical characteristics obtained from circuit simulations. If the errors are below a particular percentage, the ML model created in step 618 is deemed accurate.

The machine learning models here are representations of the behavior of the circuit blocks over a range of dominant components, environmental and usage condition variables. The dominant components, environmental and usage condition variables constitute the input variables to the model. Correlations between changes of the input variables and changes to the analog circuit specifications are determined from the data obtained from the simulations and implemented into the machine learning model through a training process. A preferred training process herein therefore includes four steps:
(a) A sensitivity analyses to identify the input variables that most affect the output, and eliminate those that do not;
(b) Splitting a resulting data set into training and testing subsets;
(c) Using the training data subset to calculate the parameters of the machine learning model with a regression method, and use the test data subset to verify that the model is accurate because it can estimate the output for that subset of inputs (test data) with little error; and
(d) Continuing to improve the accuracy of the model through guided learning until a required accuracy criterion (L1norm, L2norm, R2 score) is met,

ML modeling in the present disclosure involves a set of statistical processes that generate input-output relationship(s) for a given simulated data either in the form of equations or as regression tree (depending on the statistical process). Linear and polynomial regression modeling returns an output equation with input variables and their coefficients as dependent parameters by reducing the cost function (also known as loss function) across different iterations through an optimizer (Gradient descent method is the preferred optimizer). A gradient boosting method such as LGBM or XGBM builds regression trees using training data through gradient descent optimizer. In both cases, root mean square error between actual and predicted output values is considered as the cost function (also known as L2norm). The final coefficients of the input-output relation or weights of the regression tree are generated by ML model as a process of reducing the cost function to a minimum value, preferably to zero across the iterations.

The method that involves linear regression, polynomial regression produces ML model with input-output relationship which is used to stipulate outputs for any unseen inputs. The boosting methods such as LGBM, XGB involve regression trees and the corresponding weight vectors as a part of the model building, which are further used for unseen data prediction,

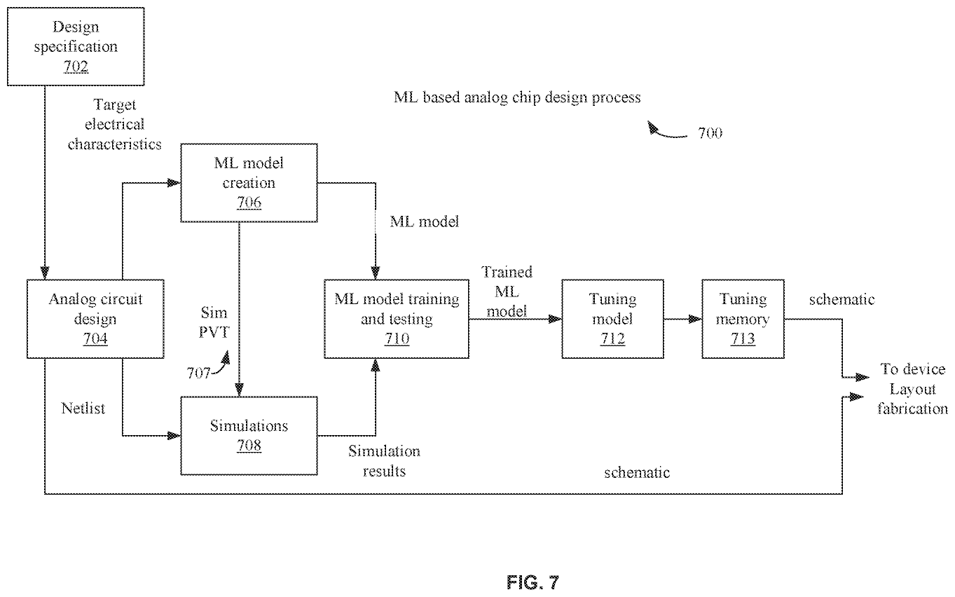

FIG. 7 is a flow diagram illustrating creating ML models and relating the ML models to a corresponding analog circuit, according to the embodiments herein. An ML-based analog chip design process 700 begins with a design specification 702 that includes a number of target electrical characteristics. The target electrical characteristics are used to create an analog circuit design 704. This is also used for ML model creation 706 and a netlist which is sent for circuit simulations 708. Simulation results are obtained from simulation runs using the netlist and the PVT conditions 707 within specified ranges. An ML model from the ML model creation 706 and the simulation results are used in ML model training and testing 710 to produce a tuning model 712 specific to the analog circuit design 704 and the PVT conditions 707. Creating ML models, in general, is conventional. For example, see, How to Develop a Machine Learning Model from Scratch, by Victor Roman, 23 Dec. 2018, towardsdatascience.com.

The machine learning models in embodiments of the present disclosure are representations of the behavior of the circuit blocks over a range of dominant components, environmental and usage condition variables. This is the first key part of the present disclosure. While the analog circuit may have many constituent components, we only look for and use the “dominant” components to build the ML model and disregard the rest. This is very efficient yet produces high accuracy.

In practice, each analog circuit may have many constituent components of various types whose electrical characteristics may change with PVT in conflicting ways. It is impractical and cost-prohibitive to directly use the electrical characteristics of all the many components as input variables (in addition to the environmental and usage condition variables) to create the ML model representing the relationship between the values of the input variables and the output variables. While the analog circuit may have many constituent components, embodiments of the present disclosure only look for and uses certain electrical characteristics of the dominant components as inputs to build the ML model and disregard the rest. This method is very efficient yet produces high accuracy. It is also scalable to large analog circuits. The resulting machine learning model is also smaller, occupying less silicon area when cast into the on-chip tuning memory. This efficient method is the first innovation of embodiments of the present disclosure.

The dominant components, environmental and usage condition variables constitute the input variables to the model. Correlations between changes of the input variables and changes to the analog circuit specifications are determined from the data obtained from the simulations and implemented into the machine learning model through a training process. This is a second key aspect of embodiments of the present disclosure. We correlate changes in the input variables (dominant components, P, V, T) within themselves and with changes in the output variables (electrical characteristics or specs of the analog circuit) to create the ML model. This is much more efficient than correlating the actual values of the input variables and the output variables to build the ML model.

Embodiments of the present disclosure uses the correlations between the changes in the input variables (in this case the electrical characteristics of the dominant components, P, V, T) within themselves and with the changes in the output variables (in this case the electrical characteristics or specs of the analog circuit) to create the ML model. In practice, each component has many electrical characteristics that may all change with PVT in conflicting ways from one to another. It is impractical and cost-prohibitive to directly use the electrical characteristics of the many components to create the ML model representing the relationship between the values of the input variables and the output variables. The present method using the correlations between changes of the input variables and corresponding changes in the output variables to build the ML model is much more efficient yet does not sacrifice accuracy. The resulting machine learning model is also smaller, occupying less silicon area when cast into the on-chip tuning memory. This efficient method is the second innovation of embodiments of the present disclosure.

If the success of a re-tuning attempt cannot be measured, it cannot be improved. It is not practical to directly measure the responses of the tunable analog circuit then use them to retune the analog circuit on-the-fly as the cost associated with extra circuit area and power would be prohibitive. Even worse, many types of responses cannot be directly measured without affecting the normal functionality of the analog circuit. Simple examples are input offset voltage, open loop gain, bandwidth, power supply rejection ratio of an operational amplifier. Therefore, using ML model to generate accurate predictions of the circuit responses is a much more efficient method as it does not require the additional monitoring circuit, yet tuning accuracy is not sacrificed. The ML model predicts what and which digital bit change controls to apply to selected tunable components in a tunable analog circuit, given input conditions PVT. This analog design method based on a very efficient ML-model is the third innovation of embodiments of the present disclosure.

All ML models require a measure of success. Embodiments of the present disclosure measure success by how well after tuning the analog circuit operating in its silicon chip adheres (stays in-tune) to its specified standards over PVT. The data results needed to judge this success are present from circuit simulations on a circuit design platform running, e.g., HSpice or Spectre.

We are making two assumptions. (1) The changes in the electrical characteristics of the outputs can be predicted given the changes in the electrical characteristics of the dominant components and the changes in PVT. (2) The available data from circuit simulation results is sufficient information to learn, train, and test the relationship patterns between the changes in the electrical characteristics of the dominant components and the changes in PVT and the corresponding changes in the electrical characteristics of the outputs.

The trained ML model 712 is distilled into a tuning memory 713. Its schematic and the schematic from the analog circuit design 704 are then sent to layout and for fabrication. The results are diagramed by the silicon chip in FIG. 3.

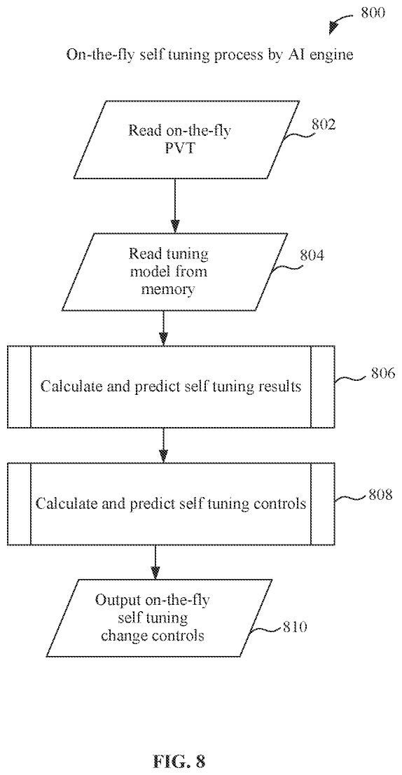

FIG. 8 shows the on-the-fly self-tuning process by the AI engine. The AI engine executes an inference program. First, it fetches the on-the-fly PVT data 802 from the PVT sensors in digital format then reads the tuning model 804 from memory. The AI engine then solves for the output under the measured PVT conditions. It will then calculate the output under nominal condition and compare the output under the measured PVT conditions to the output under the nominal condition. If the difference is beyond a certain limit (e.g., 2-3% as defined by the user) it will predict the self-tuning results 806 then calculate the self-tuning change controls 808 necessary to bring the difference back to below the limit. The output is a set of change control bits 810 that the AI engine sends to the adaptation controller to turn on the right switches that would make the necessary changes in the analog circuit,

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. An Integrated Circuit (IC), comprising:
an analog circuit comprising a plurality of tunable components each configured to respond to a plurality of change control bits, wherein each tunable component is configured to change its electrical characteristics such that together each of the tunable component is enabled to retune the analog circuit to attain a predefined set of electrical characteristics;
a Process, Voltage Temperature (PVT) characteristics monitor comprising a plurality of PVT sensors;
a tuning memory embedded with a machine learning (ML) model of the analog circuit; and
an artificial intelligence (AI) engine configured to receive a PVT signal input from the plurality of PVT sensors and the machine learning model embedded in the tuning memory, wherein the AI engine is configured to:
fetch an on-the-fly PVT signal inputs from the plurality of PVT sensors;
compute a plurality of analog circuit target control inferences and predictions based the on-the-fly PVT signal inputs and the ML model; and
generate a plurality of change control bits from the predictions based on the ML model, where the plurality of change control bits activates one or more digital switches to retune the analog circuit.

2. The integrated circuit of claim 1, wherein the ML model is trained and tested with a plurality of results of a series of design simulations of the analog circuit, where the ML model is stored as a tuning model which represent a correlation between the signal inputs and an output target control variables based on which the AI engine calculates the plurality of analog circuit target control inferences and predictions.

3. The Integrated Circuit of claim 1, wherein the tuning model comprises at least one of a polynomial regression model and an ensembled-regression model.

4. The Integrated Circuit of claim 1, wherein the ML model is configured to represent the correlations between the changes in electrical characteristics of the tunable components and the changes in the electrical characteristics of the analog circuit under each detected set of PVT conditions, to accurately predict the new electrical characteristics of the analog circuit after the changes of the tunable components are applied during the re-tuning process.

5. The Integrated Circuit of claim 1, wherein the ML model is configured to identify an electrical characteristic value of each tunable component of the plurality of tunable components to re-tune the analog circuit to attain the predefined set of electrical characteristics.

6. The Integrated Circuit of claim 1, wherein the AI engine is further configured to issue on-the-fly change controls to negate adverse de-tuning effects of real-time PVT variations affecting the analog circuit to attain the predefined set of electrical characteristics.

7. The Integrated Circuit of claim 1, further comprising a change control register configured to store the plurality of change control bits through connections to the plurality of tunable components.

8. The Integrated Circuit of claim 5, wherein each tunable component of the plurality of tunable components is responsive to at least one single binary control in the plurality of change control bits, where one or more tunable components are identified in circuit design simulations to be more influential than others in re-tuning of the analog circuit.

9. The Integrated Circuit of claim 1, wherein the plurality of PVT sensors comprises:
a first sensor collocated with the tuning memory, the AI engine and the analog circuit configured to provide a real-time measurement of device process outcomes (P);
a second sensor collocated with the tuning memory, the AI engine and the analog circuit configured to provide a real-time measurement of operating voltages (V); and
a third sensor collocated with the tuning memory, the AI engine and the analog circuit configured to provide a real-time measurement of operating temperatures(T).

10. A method of automatically re-tuning an analog circuit on an Integrated Circuit, the method comprising:
configuring a plurality of tunable components of the analog circuit to respond to a plurality of change control bits, wherein each tunable component is configured to change its electrical characteristics such that together each of the tunable component is enabled to retune the analog circuit to attain a predefined set of electrical characteristics;
obtaining, by a PVT monitor comprising a plurality of PVT sensors, a plurality of PVT signal inputs;
reconstituting, by a tuning memory, a Machine Learning (ML) model from a tuning model embedded in the tuning memory to infer and calculate predictions based on the plurality of PVT signal inputs sensed by the plurality of PVT sensors;
fetching, by an artificial intelligence (AI) engine, on-the-fly PVT signal inputs from the plurality of PVT sensors;
computing, by the AI engine, a plurality of analog circuit target control inferences and predictions based the on-the-fly PVT signal inputs and the ML model; and
generating, by the AI engine, a plurality of change control bits from the predictions based on the ML model, where the plurality of change control bits activates one or more digital switches for automatically retuning the analog circuit.

11. The method of claim 10, wherein the ML model is trained and tested with a plurality of results of a series of design simulations of the analog circuit, where the ML model is stored as a tuning model which represent a correlation between the signal inputs and an output target control variable based on which the AI engine calculates the plurality of analog circuit target control inferences and predictions.

12. The method of claim 10, further comprising enabling the ML model to represent the correlations between the changes in electrical characteristics of the tunable components and the changes in the electrical characteristics of the analog circuit under each detected set of PVT conditions, to accurately predict the new electrical characteristics of the analog circuit after the changes of the tunable components are applied during the re-tuning process.

13. The method of claim 10, wherein the ML model is configured to identify an electrical characteristic value of each tunable component of the plurality of tunable components to re-tune the analog circuit to attain the predefined set of electrical characteristics.

14. The method of claim 10, further comprising configuring the AI engine to issue on-the-fly change controls to negate adverse de-tuning effects of real-time PVT variations affecting the analog circuit.

15. The method of claim 10, further comprising providing a change control register configured to store the plurality of change control bits via connections to the plurality of tunable components.

16. The method of claim 15, wherein each tunable component of the plurality of tunable components is responsive to at least one single binary control in the plurality of change control bits, where one or more tunable components are identified in circuit design simulations to be more influential than others in re-tuning of the analog circuit.

17. The method of claim 16, wherein the plurality of PVT sensors comprises:
a first sensor collocated with the tuning memory, the AI engine and the analog circuit configured to provide a real-time measurement of device process outcomes (P);
a second sensor collocated with the tuning memory, the AI engine and the analog circuit configured to provide a real-time measurement of operating voltages (V); and
a third sensor collocated with the tuning memory, the AI engine and the analog circuit configured to provide a real-time measurement of operating temperatures (T).
